(19) United States
(12) Patent Application Publication
(10) Pub. No.: US 2016/0296001 A1
(43) Pub. Date: Oct. 13, 2016

(54) CAN HOLDER

(71) Applicant: Robert FOX, Mentor, OH (US)

(72) Inventor: Robert FOX, Mentor, OH (US)

(21) Appl. No.: 14/683,708

(22) Filed: Apr. 10, 2015

(51) Int. Cl. A45F 5/10; A47J 43/22

(52) U.S. Cl. CPC A45F 5/10; A47J 43/22

(57) ABSTRACT

In an example embodiment, there is described herein a can holder (or can securing device) that comprises a handle that comprises a top and a bottom end, a toggle latch handle pivotally coupled with the handle at the top end, a toggle latch hook pivotally connected to the toggle latch handle, and a channel formed at the bottom end of the handle. Attaching the can securing device to the side of a can provides a user with a stable handle. This handle allows the user to safely control and maneuver the can with one hand, enabling the other hand to perform other tasks such as emptying the contents of the can. This can alleviate the risk of dropping the can and/or the risk of personal injury.

### BACKGROUND

The present disclosure relates to a device for facilitating the handling of cans such as industrial cans.

Currently, individuals and establishments prepare foods, and many of these foods are packaged in industrial sized cans (e.g., #10 cans that are about 102 ounces, 6¼ inches in diameter and 7 inches tall). These cans are hard to hold, and removing foods, especially pasty foods, can be difficult and dangerous. The user is at risk of dropping the can or slicing their hand on the can's sharp rim. Maneuvering around the cans sharp edges and bulky structure makes this elementary task difficult.

As can be seen, there is a need for a device that easily secures an industrial sized can.

### BRIEF DESCRIPTION OF THE DRAWINGS

The Figures illustrate multiple perspective views and an example embodiment of the present invention in use.

FIG. 1 illustrates an example of a perspective view of a can holder with the toggle latch handle in an open or unlocked position.

FIG. 2 illustrates an example of the perspective view of FIG. 1 with the toggle latch handle in the closed or locked position.

FIG. 3 illustrates an example of a second perspective view of the can holder illustrated in FIG. 1, rotated approximately ninety degrees clockwise with the toggle latch handle in the closed or locked position.

FIG. 4 illustrates an example of a third perspective view of the can holder illustrated in FIG. 1, rotated approximately ninety degrees counterclockwise with the toggle latch handle in the open or unlocked position.

FIG. 5 illustrates an example of the can holding device described herein secured to an industrial can.

FIG. 6 illustrates an example of a strainer that is suitable to be employed with the can holder described in FIGS. 1-5.

FIG. 7 is a side view of the strainer illustrated in FIG. 6.

FIG. 8 is a cut away view illustrating an example of the strainer being employed with the can holder described in FIGS. 1-5.

FIG. 9 illustrates an exploded view of the area in FIG. 8 where the can holder engages the strainer.

### OVERVIEW OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with an example embodiment, there is disclosed herein a can securing device comprising: a handle comprising a top end and a bottom end; a toggle latch handle pivotally connected to the handle at the top end; a toggle latch hook pivotally connected to the toggle latch handle; and a channel formed at the bottom end of the handle.

### Description of Example Embodiments

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

In an example embodiment, there is described herein a can securing device comprising a handle that comprises a top and a bottom end, a toggle latch handle pivotably coupled with the handle at the top end, a toggle latch hook pivotally connected to the toggle latch handle, and a channel formed at the bottom end of the handle. Attaching the example embodiment to the side of a can provides a user with a stable handle. This handle allows the user to safely control and maneuver the can with one hand, enabling the other hand to perform other tasks such as emptying the contents of the can. This can alleviate the risk of dropping the can and/or the risk of personal injury.

Referring now to the Figures, there is illustrated a can holder 1. The can holder 1 comprises a handle having a top end and a bottom end. The top end of the handle includes a toggle latch handle 4 pivotally connected to the handle 2 by a fastener 5. A toggle latch hook 3 may be pivotally coupled with the toggle latch handle 4. The toggle latch hook 3 may include a tab (or hook) 7 that can be secured to a first (e.g., top) end of a can. At the bottom of handle 2 a curved channel 6 is formed. The curved channel 6 conforms to a second (e.g., bottom) end of a can. A pad 8 may be coupled with handle 2 and can be employed to provide additional stability. The pad 8 may be formed in the shape of the can to be secured.

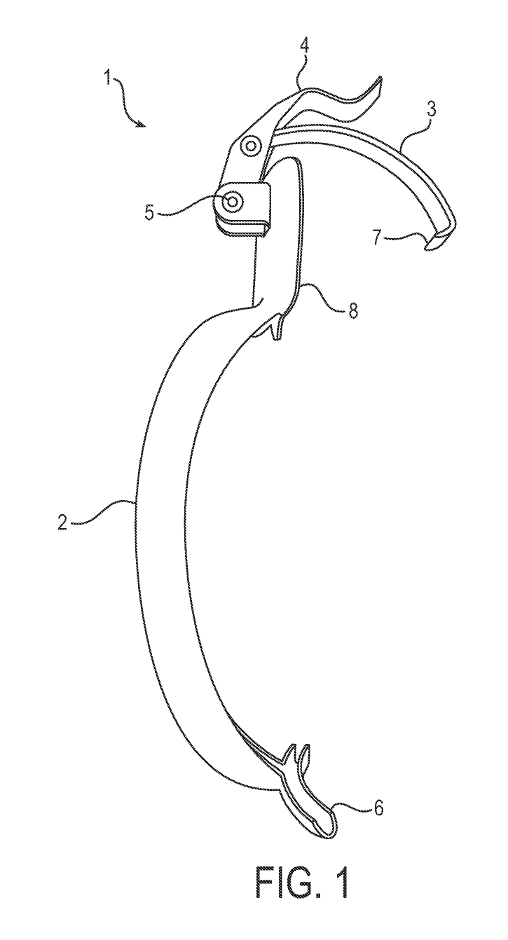

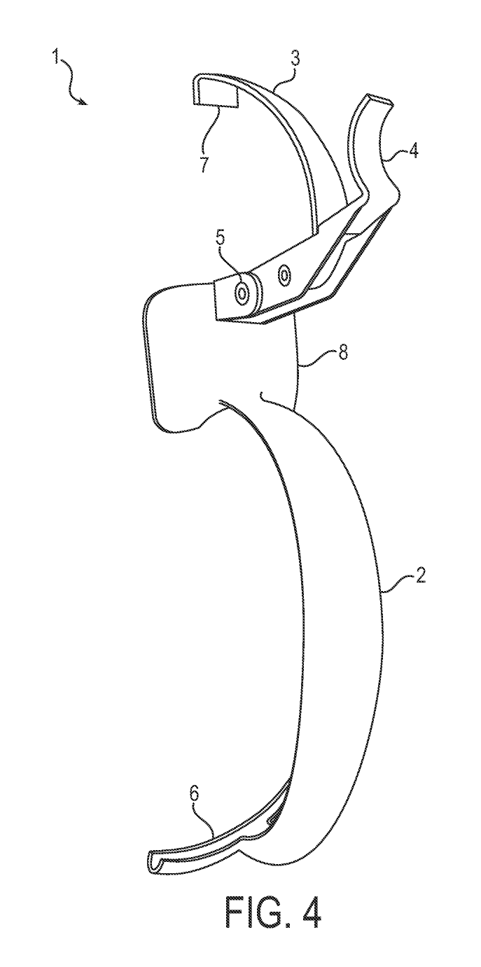

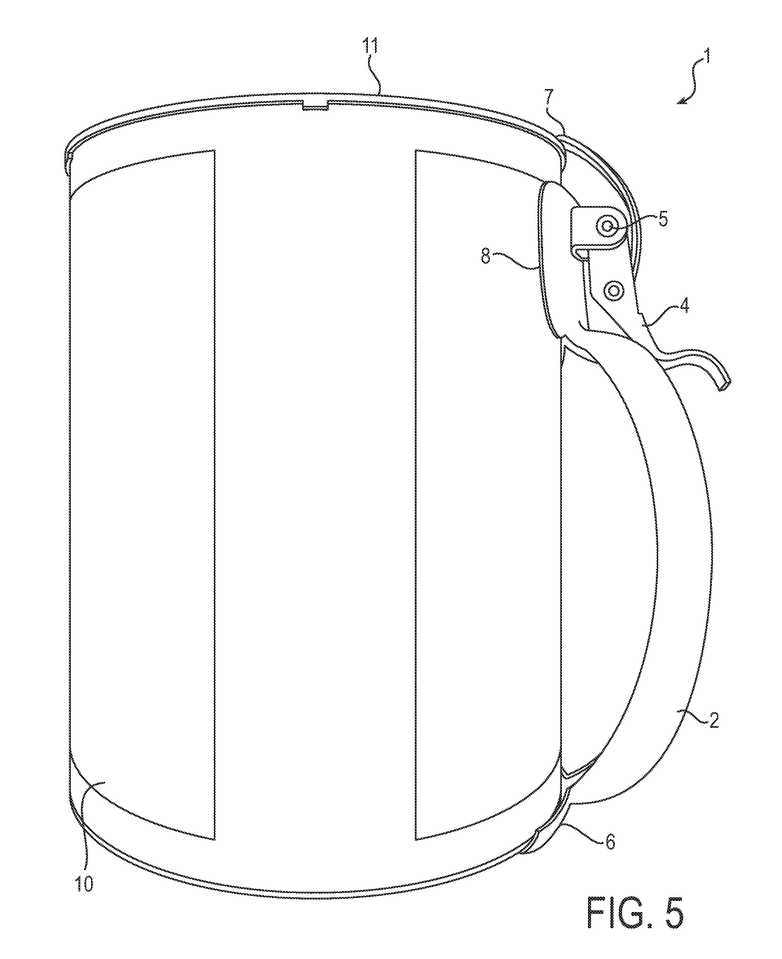

Referring to FIG. 5, there is illustrated an example of the can holder 1 engaged with a can 10. The toggle hook latch 3 is attached to the lower fastener hole of the toggle latch handle 3 with one of the fasteners 5. The toggle latch assembly 3,4 is attached to the handle 2 with a fastener 5. The second of the handle 2 is placed under the second (e.g., bottom) end of the can 10. As the bottom of the handle 2 is engaged with the bottom rim of the can 10, the handle 2 is positioned against the side of the can 10. With the toggle latch handle 4 in the open or unlocked (see e.g., FIG. 1 or FIG. 4) positioned, the tab (or hook) 7 of the toggle latch hook 3 can rest on the first (upper) edge of the can 10.

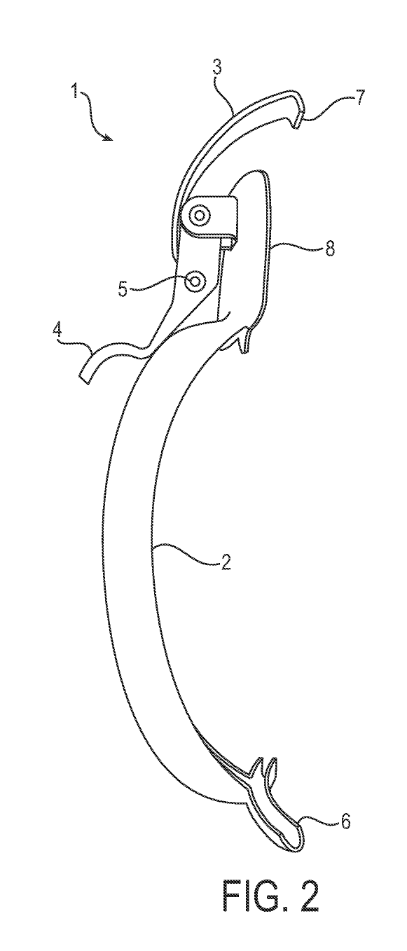

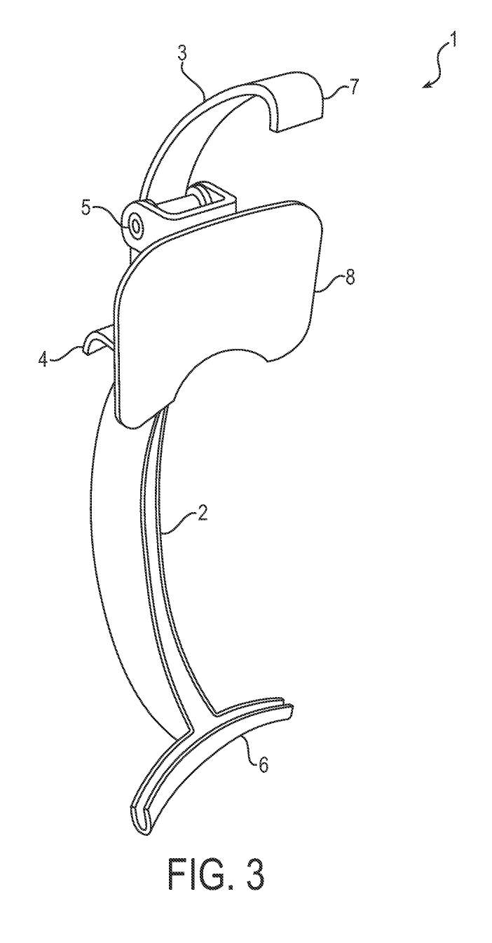

Closing the toggle latch handle 4 to the closed or locked position (see e.g., FIG. 2 or FIG. 3) which will secure the can holder 1 to the can 10. When the toggle latch handle is in the closed or locked position, the curved channel 6 a first side of the can (e.g., the top side) and the tab 7 engages a second side (e.g. bottom) of the can.

In alternate embodiments, the latch and the handle could be reversed, meaning upper edge of handle would attach to top rim of can and latch to the bottom edge of can. A rubber coating on handle could reduce slippage and add comfort. The present invention could also be used in the paint industry. The food service can 10 and a standard gallon sized paint can are similar in size and shape. To use this invention, one would simply hook bottom of handle to bottom of can and lock top of handle to top rim of can.

In accordance with an example embodiment, the following features may be employed for securing a #10 can:
The handle 2 may be a metal or plastic fabricated handle, which may measure at about 6 inches in length and about 2 inches in width and with sufficient handle length and width accommodate the hand of any adult.
The toggle latch hook 3 may be fabricated from metal or plastic and measure about 2.25 inches in length and about 0.375 inches in width.
The toggle latch handle 4 may be fabricated from metal or plastic and may measure about 2 inches in length and about 0.375 inches in width
The metal fasteners 5 may be about 0.25 inches in length and about 0.125 inched in diameter.
The curved channel 6 at the bottom of the handle may be contoured to conform to the bottom rim of the #10 can.
The pad 8 may be curved to match the curve of a #10 can.

Although the above example provides a description and dimensions for engaging a #10 can, those skilled in the art should readily appreciate that the measurements and shapes may be modified to fit any desired type or shape of can. For example, the length of the handle 2 can be adjusted for cans of different heights. The curves for curved channel 6 and pad 8 can be modified to fit a can of any radius, or may be straight for rectangular cans.

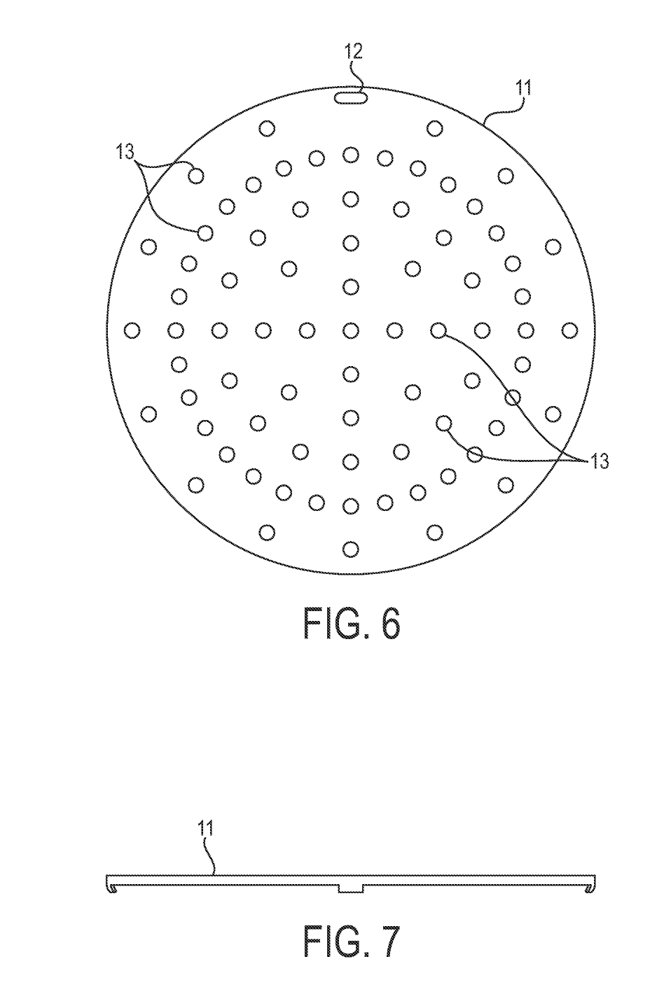

FIGS. 6 and 7 illustrates an example of a strainer that is suitable to be employed with the can holder described in FIGS. 1-5. The strainer comprises a slot 12 being of an appropriate size to engage the tab 7 of the can holder 1. In the example illustrated in FIG. 6, the strainer further comprises a plurality of holes 13 that can allow liquid to escape from the can, however, those skilled in the art can readily appreciate that any suitable type of strainer (e.g., mesh, screen) can be employed. In particular embodiments, the strainer may further comprise clips to facilitate holding the strainer in place while in use.

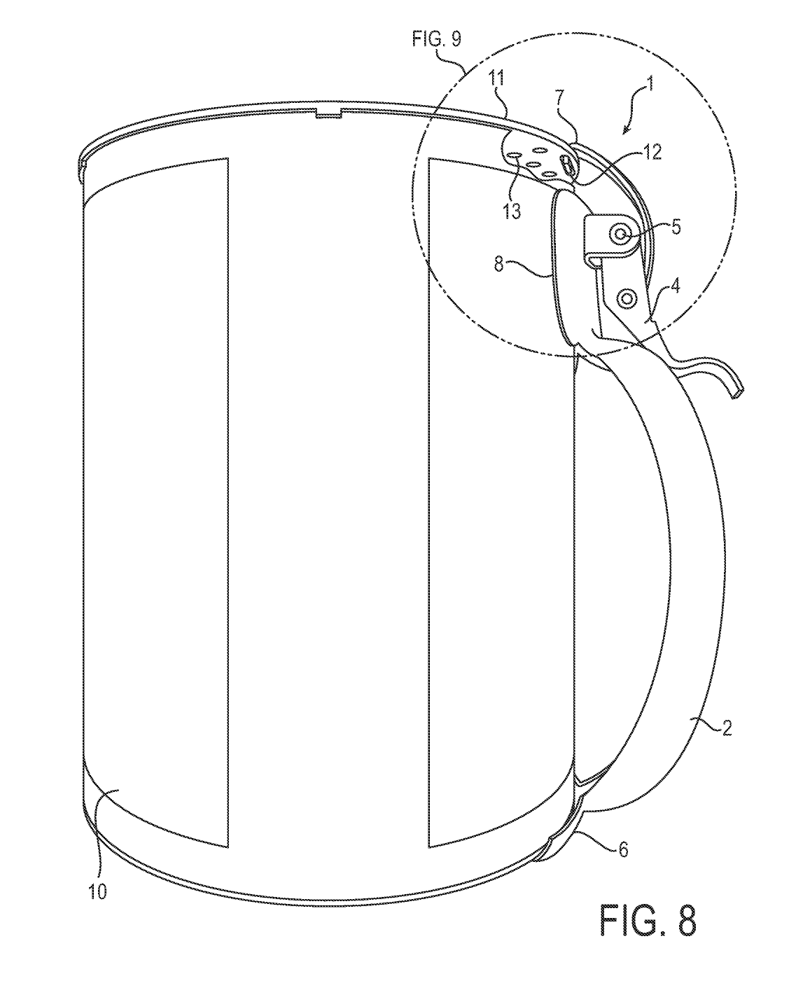

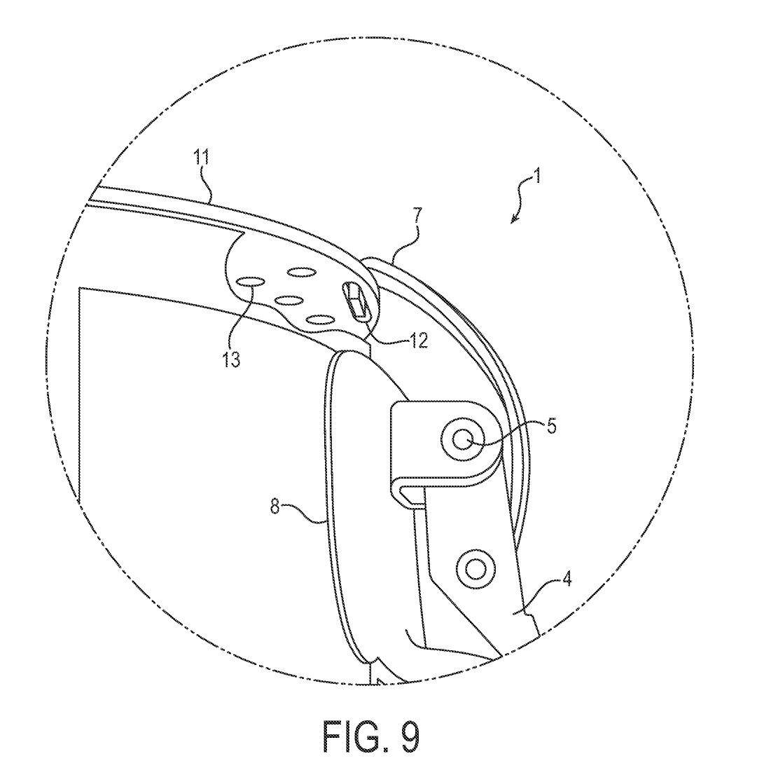

FIG. 8 is a cut away view illustrating an example of the strainer being employed with the can holder described in FIGS. 1-5. As can be observed from FIG. 8, the tab 7 of the can holder 1 engages the slot 12 of the strainer 11 which holds the strainer in place when the toggle latch handle 4 is in the locked position. FIG. 9 illustrates an exploded view of the area in FIG. 8 where the can holder 1 engages the strainer 11.

It should be understood, of course, that the foregoing relates to exemplary embodiments of the invention and that modifications may be made without departing from the spirit and scope of the invention as set forth in the following claims.

What is claimed is:

1. An apparatus, comprising:
a handle comprising a top end and a bottom end;
a toggle latch handle pivotally connected to the handle at the top end;
a toggle latch hook pivotally connected to the toggle latch handle; and
a channel formed at the bottom end of the handle;
wherein the channel is shaped to engage a surface of a can to be secured.

2. The apparatus set forth in claim 1, wherein the toggle latch hook further comprises a tab for engaging a second surface of the can to be secured.

3. The apparatus set forth in claim 2, wherein when the toggle latch handle is in a closed position, the tab and the channel secure the can.

4. The apparatus set forth in claim 1, further comprising a pad coupled with the handle.

5. The apparatus set forth in claim 4, wherein the pad is shaped to engage a predetermined shaped can.

6. The apparatus set forth in claim 1, wherein the channel is curved to fit a can of a predetermined radius.

7. The apparatus set forth in claim 1, further comprising a strainer having a slot of an appropriate size to engage the toggle latch hook;
wherein when the strainer is deployed the toggle latch hook holds the strainer in place.

8. The apparatus set forth in claim 7, wherein the strainer comprises a plurality of holes.
